(19) United States
(12) Patent Application Publication
(10) Pub. No.: US 2022/0341360 A1
(43) Pub. Date: Oct. 27, 2022

(54) COOLANT EQUALIZING RESERVOIR WITH INTEGRATED DUCT-LIKE DEGASSING CHAMBER

(71) Applicant: Röchling Automotive SE & Co. KG, Mannheim (DE)

(72) Inventors: Marco Barbolini, Bolzano (IT); Zaoli He, Suzhou (CN)

(21) Appl. No.: 17/724,615

(22) Filed: Apr. 20, 2022

(30) Foreign Application Priority Data
Apr. 23, 2021 (DE) 10 2021 110 489.0

(51) Int. Cl. F01P 11/02

(52) U.S. Cl. CPC F01P 11/029; F01P 11/028

(57) ABSTRACT

A coolant equalizing reservoir for arrangement in a coolant circuit, having:
a reservoir housing,
a degassing chamber in the reservoir housing, inside the former of which coolant flow along a curved degassing flow path,
a feed line for introducing coolant into the reservoir housing, and
an outflow opening for discharging coolant from the reservoir housing,
   where both the feed line and the outflow opening open into the degassing chamber, and where it is provided that the degassing chamber is configured as a flow duct proceeding along a curved duct path, where the duct path defines the degassing flow path.

This Application claims priority in German Patent Application DE 10 2021 110 489.0 filed on Apr. 23, 2021, which is incorporated by reference herein.

The present invention concerns a coolant equalizing reservoir for arrangement in a coolant circuit, in particular in a motor vehicle, comprising:
A reservoir housing,
A degassing chamber in the reservoir housing, inside the former of which coolant flows along a curved a degassing flow path,
A feed line for introducing coolant into the reservoir housing, and
An outflow opening for discharging coolant from the reservoir housing,

Where both the feed line and the outflow opening open into the degassing chamber.

### BACKGROUND OF THE INVENTION

Such a coolant equalizing reservoir, hereunder also referred to in brief only as “equalizing reservoir”, is known from DE 10 2008 060 088 B4. Like the equalizing reservoir of the present invention, this known equalizing reservoir is also suitable and intended for arrangement in a coolant circuit of a motor vehicle, hereunder referred to in brief as “cooling circuit”.

Such equalizing reservoirs in the cooling circuit usually fulfill two tasks: For one thing, they provide an equalizing volume, in order to take up a volume increase of the coolant circulating in the cooling circuit effected by a temperature increase. For another, mostly via vortex chambers as degassing chambers, equalizing reservoirs ensure degassing of the coolant which is advantageous for preventing undesirable cavitation at conveying devices used for conveying the coolant in the cooling circuit, such as for instance at pump wheels and valves.

Known cooling circuits with equalizing reservoirs for motor vehicles with internal combustion engines are operated at a volume flow of approximately 5 l/min. Surprisingly, battery-run electric vehicles require quantitatively higher coolant flows of 10 or even 12 l/min or more to cool their heating-up vehicle components. With an increasing volume flow of the coolant, its degassing becomes more difficult, which presumably at a given accommodating volume of the equalizing reservoir is associated with the shortening dwell time of the coolant in the equalizing reservoir.

Numerous further equalizing reservoirs are known from the state of the art. With a certain relevance for the present invention, one may additionally refer to the equalizing reservoir of DE 100 50 852 A1, which proposes a spatial region situated outside a vortex chamber but in the equalizing reservoir, subdivided into expansion chambers by means of partitions.

In order to realize savings potentials in materials and production costs, part of the vortex chamber walls of the vortex chambers bounding the vortex chambers in the radial direction relative to the vortex chamber's axis, which are integrated into the equalizing reservoirs known respectively from DE 10 2008 060 088 B4 and DE 100 50 852 A1, is at the same time also respectively part of the reservoir wall of the reservoir housing. Furthermore, both state-of-the-art publications propose configuring the vortex chamber rotation-symmetrically in respect of a virtual vortex chamber axis, such that there develops in the vortex chamber a vortex flow circling the vortex chamber's axis multiple times. This configuration of the vortex chamber occupies a relatively large construction volume.

### SUMMARY OF THE INVENTION

It is the task of the present invention to improve the equalizing reservoir mentioned at the beginning in such a way that even at higher volume flows of coolant above 10 or even above 12 l/min, it efficiently makes possible a thermally induced expansion of the coolant and its degassing with the smallest possible requirement of installation space.

This task is solved by the present invention in an equalizing reservoir as mentioned at the beginning, by having the degassing chamber configured as a flow duct proceeding along a curved virtual duct path, where the virtual duct path defines the virtual degassing flow path.

Unlike in the state of the art, therefore, the degassing chamber is not or mostly not constructed rotation-symmetrically between the mouth of the feed line and the mouth of the outflow opening. Since in state-of-the-art rotation-symmetrical vortex chambers, the central volume region of the vortex chamber is not normally reached by liquid during operation, this central volume region, penetrated through by the virtual vortex chamber axis, forms in the vortex chamber a kind of dead volume of the equalizing reservoir. This dead volume is avoided by the present design with a duct-like degassing chamber. Therefore also in the present case, it is not the term “vortex chamber” but rather “degassing chamber” that is used for the space into which the coolant is directly introduced and in which the greatest part of the degassing occurs.

Using the duct-like degassing chamber, the coolant flows, as in a-state-of-the art vortex chamber, along a curved degassing flow path, which favors the degassing, however not in a vortex flow. If the degassing flow path proceeds in the circumferential direction about a degassing chamber axis as the or an axis of curvature of the degassing flow path, the degassing chamber axis preferably does not penetrate through the degassing chamber but instead preferably proceeds outside the same.

The duct-like nature of the degassing chamber can moreover be manifested in an advantageous configuration of the present invention by the degassing chamber being bounded at least along a section of the course of the duct path by a first wall and by a second wall lying opposite the first wall, where an inner surface of a wall out of the first and the second wall which faces towards the interior space of the degassing chamber is curved concavely along the section and where an inner surface of the respective other wall out of the first and the second wall which lies opposite the concave inner surface is curved convexly along the section.

The virtual duct path and thereby the first and the second wall can each be curved only in one direction of curvature. Depending on the requirements in respect of the degassing of the coolant being used, however, the virtual duct path can be curved in different directions of curvature in consecutive sections. Thus the virtual duct path can exhibit an S-shape and/or a shape consisting of several consecutive curved sections each with a different, in particular opposite, direction of curvature, respectively. Between curved sections the virtual duct path can exhibit straight sections. Different curved sections can exhibit different lengths and/or different curvatures, where a different curvature can be manifested for example in different radii of curvature and/or in different directions of curvature. A convex wall and an opposite concave wall should therefore be understood in terms of the present application as a convex section of a wall and/or as a concave section of a wall respectively.

By definition, the first and the second wall follow the virtual duct path at a distance from the latter, where the first and the second wall are located on different sides of the virtual duct path and/or of the virtual degassing flow path respectively.

The concave inner surface section and a convex inner surface section lying opposite to it can converge towards one another, that is, approach one another, in order to form a constriction along the virtual duct path from the mouth of the feed line to the outflow opening, or can diverge, that is, veer away from one another, in order to form a diffuser section along the virtual duct path from the outlet of the feed line to the outflow opening. In order to form a choke, the inner surfaces and/or inner surface sections respectively can first converge and subsequently diverge. In order to avoid a change in velocity of the degassing flow along the duct path and/or degassing flow path respectively, the concave inner surface section and the convex inner surface section can proceed in parallel to one another. If there exist several axes of curvature about which the degassing flow path is curved, at least one of the axes of curvature proceeds outside the degassing chamber. Preferably all axes of curvature of the degassing chamber, at least all those of them that are parallel to one another, proceed outside the latter in order to achieve a slim curved degassing chamber.

In principle, the degassing chamber into which the coolant is introduced can exhibit a nearly arbitrary shape. To achieve the least possible turbulent flow after introducing the coolant into the degassing chamber, the first and/or the second wall of the degassing chamber exhibits a kink-free concavely curved inner surface. Preferably the inner surface of the wall is free from flow obstacles, such as for example crosspieces protruding from the inner surface or deflector plates which protrude from the wall towards the degassing chamber's axis. To facilitate production, the first wall and/or the second wall can exhibit a part-circular-cylindrical or part-elliptical-cylindrical surface facing towards the interior space of the degassing chamber.

According to a preferred embodiment form of the equalizing reservoir discussed here, the first and the second wall can protrude from a base-wall section of the reservoir housing along a degassing chamber axis as an axis of curvature of the degassing flow path and be arranged at a distance from one another orthogonally to the degassing chamber axis.

In principle, the base-wall section from which the walls bounding the degassing chamber: first and second wall, protrude, can be an arbitrary wall section of the reservoir housing, for example a side-wall of the reservoir or a section of the reservoir top or of the reservoir bottom. Preferably, the base-wall section is a section of the reservoir bottom or of the reservoir top lying opposite the reservoir bottom, such that in the finally assembled, operational state, the degassing chamber's axis proceeds essentially in parallel to the gravitational direction or at least in a cone with a half apex angle of 10° about a cone axis parallel to the gravitational direction which intersects the degassing chamber's axis. Then a coolant flow introduced into the degassing chamber can advantageously flow along a degassing flow path curved about the degassing chamber's axis, where the gravitational force has essentially the same effect on the flowing coolant at every circumferential location along the degassing flow. If the degassing chamber's axis is inclined too steeply relative to the gravitational direction, undesirable flow separation can occur at the then existing upper vertex of the degassing flow about the degassing chamber's axis.

The equalizing reservoir can advantageously be formed in an injection molding process and for example comprise an upper and a lower reservoir shell. Preferably the lower reservoir shell comprises the reservoir bottom and part of the side-walls of the reservoir. Preferably the upper reservoir shell comprises the reservoir top and part of the side-walls of the reservoir. In this preferred case, each reservoir shell comprises part of the degassing chamber, where preferably the respective part of the degassing chamber is configured integrally with the reservoir shell exhibiting it. The two reservoir shells can be bonded, in particular welded, with one another, for example by mirror welding or by another suitable welding or alternatively gluing method.

In order to achieve maximum constructional freedom for the layout of the degassing chamber, preferably each of the two walls out of the first and the second wall is arranged, at least along a section of the curved duct path, at a distance from the reservoir housing in a direction orthogonal to the degassing chamber's axis.

In principle, this should not preclude shared utilization of a section of a side-wall of the reservoir housing as a section of the first wall or of the second wall also. Preferably, however, the duct-like degassing chamber proceeds right through the equalizing reservoir. In order to obtain a duct-like degassing chamber with the longest possible course, the degassing chamber can begin and/or end at a wall section of the reservoir housing. According to an advantageous development, therefore, the wall with the convex inner surface section can come out from a side-wall of the reservoir housing and end in a side-wall of the reservoir housing and thereby together with the reservoir housing enclose a spatial volume located outside the degassing chamber.

In order to be able also to utilize a volume region outside the degassing chamber but inside the equalizing reservoir for accommodating coolant, at least one wall out of the first and the second wall can exhibit at least one passage aperture which completely penetrates through the wall in the thickness direction. For the most loss-free exchange possible of coolant between a volume in the degassing chamber and a volume outside it, at least one wall out of the first and the second wall can exhibit a plurality of passage apertures, each of which completely penetrates through the at least one wall in the thickness direction, where at least two of the passage apertures are arranged at different circumferential positions in the circumferential direction about the degassing chamber's axis and/or at different positions in a direction along the degassing chamber axis and/or exhibit different shapes and/or different aperture cross-sectional areas. By configuring the passage apertures with different shapes, for instance circular and elliptical or round and polygonal, and/or different aperture cross-sectional areas, different flow conditions can be adjusted for the transition flow between the interior space and the external environment of the degassing chamber at different locations along the degassing flow path and/or the degassing chamber's axis, whereby degassing can be promoted.

The passage aperture is preferably configured at a location which in the operational state of the equalizing reservoir is situated geodetically as low as possible, such that the coolant can be introduced into the degassing chamber at a location which is situated geodetically as high as possible, and consequently it travels the longest possible path inside the degassing chamber before it reaches the passage aperture. Preferably the passage aperture is arranged in such a way that a section of it is bounded by the reservoir bottom.

The above notwithstanding, the outlet of the feed line can be located in the degassing chamber at the same height as at least one passage aperture. This is possible in particular at high volume flows of 12 l/min or more, for instance of more than 20 l/min or more than 30 l/min. Therefore the outlet of the feed line can also be situated at a geodetically low, in particular at the geodetically lowest location of the degassing chamber. Due to the high volume flow, the introduced coolant can then rise from the geodetically low outlet, thus extending its flow path and therefore its dwell time.

In order to increase the dwell time of coolant in the degassing chamber and to utilize the inner volume of the degassing chamber, the feed line and an outlet line going off from the outflow opening and conducting coolant away from the degassing chamber can proceed towards the inlet opening and/or away from the outflow opening respectively with a course component orthogonal to a spacing straight line which connects the inlet opening of the feed line with the outflow opening, in particular a component along the degassing chamber's axis. Thereby, in addition to the forced flow from the inlet opening to the outflow opening, flow along the degassing chamber's axis can also be achieved. Thereby, an end-section of the feed line proceeding up to the inlet opening and a start-section of the outlet line coming out directly from the outflow opening can proceed in parallel to one another or proceed in different directions relative to the degassing chamber's axis and/or to the spacing straight line.

In principle it can suffice if the degassing chamber extends along the degassing chamber's axis over only part of the space provided in the interior of the reservoir housing. In order to provide the largest possible degassing volume along the flow path inside the degassing chamber, however, it is advantageous if the degassing chamber extends from the base-wall section of the reservoir housing along the degassing chamber's axis up to an end-wall section of the reservoir housing lying opposite the base-wall section. Preferably the degassing chamber thus extends from the reservoir bottom up to the opposite reservoir top.

Additionally or alternatively, the degassing chamber of the equalizing reservoir of the present invention can exhibit at the base-wall section, and preferably also at the end-wall section, a wall section configured together with the reservoir housing's wall for forming an inner wall surface bounding the degassing chamber and oriented transversely to the degassing chamber's axis.

A flow baffle can be arranged inside the degassing chamber for better guiding of a coolant flow into the degassing chamber. In order to achieve a coolant flow which as far as possible follows the inner surface of the first wall and/or of the second wall of the degassing chamber, the flow baffle can proceed along these inner surfaces of the degassing chamber at a distance from these inner surfaces. Preferably the flow baffle projects from the same base-wall section or end-wall section along the degassing chamber's axis as the wall of the degassing chamber. Preferably the flow baffle is curved about the degassing chamber's axis or about an axis of curvature parallel to the degassing chamber's axis. Since the flow baffle should preferably influence the course of the coolant flow in its inlet region into the degassing chamber, it suffices if the flow baffle extends only over part of the dimension of the degassing chamber which is axial in respect of the degassing chamber's axis. The flow baffle is preferably situated completely in a reservoir shell carrying it, as it is elucidated in greater detail further below. Likewise preferably, the flow baffle if present is configured only in the lower or only in the upper reservoir shell. The flow baffle preferably extends in the region of the flow inlet into the degassing chamber, that is, approximately along the degassing chamber's axis in an axial region shared with the mouth of the feed line.

For the aforementioned reasons, the flow baffle if present is preferably configured in that reservoir shell which also exhibits the mouth of the feed line into the degassing chamber.

In principle, the region outside the degassing chamber but inside the reservoir housing can be free from flow obstacles. Preferably, however, the region inside the reservoir housing but outside the degassing chamber is subdivided into a plurality of chambers which communicate with one another. Such chambers are referred to in the state of the art as expansion chambers, since they serve more strongly than the flow-conducting degassing chamber for accommodating the temperature-induced volume increase of the coolant. In principle, the chambers are separated from one another by partitions, where the region inside the reservoir housing but outside the degassing chamber should be so configured that flow is possible between the chambers in order to be able to utilize the entire volume of the equalizing reservoir outside the degassing chamber for the coolant, for instance for accommodating a temperature-induced volume increase.

To this end, the partitions which separate two neighboring chambers from one another preferably exhibit at least one communicating aperture each through which coolant can flow from one of the chambers into the respective neighboring one.

All the partitions can each exhibit at least one communicating aperture. Alternatively, at least one partition can be free from a communicating aperture. A chamber volume bordering it is then preferably accessible through a passage aperture directly from the degassing chamber. The partition free from communicating apertures preferably extends all the way across between the reservoir housing and the degassing chamber.

To further promote the degassing of the coolant, the communicating apertures of at least two partitions can be arranged at different distances from the degassing chamber and/or be arranged at different positions in a direction along the degassing chamber's axis. Additionally or alternatively, in order to achieve different flow conditions when flowing across between two neighboring chambers, the communicating apertures of different partitions can exhibit different shapes and/or different aperture cross-sectional areas.

Preferably the planar partitions—where for each planar partition it is the case that its thickness dimension is significantly shorter than its physical main extension directions which are orthogonal to one another and to the respective local thickness direction—extend with at least one of their physical main extension directions in parallel to the degassing chamber's axis. Although this is not imperative, the configuration of planar partitions is preferable.

In principle, it is conceivable that the partitions extend along the degassing chamber's axis only over part of the corresponding dimension of the degassing chamber. For careful degassing of the quantitatively large volume flows of coolant mentioned at the beginning, however, it is preferable if partitions which separate two neighboring chambers from one another extend from a reservoir bottom up to a reservoir top which is opposite to the reservoir bottom.

The partitions too, are preferably formed by injection molding integrally with the respective reservoir shells carrying them. The partitions and/or the first wall and/or the second wall can each comprise part-walls, of which every part-wall of a wall is configured at a different reservoir shell out of the upper and lower reservoir shell and which at their longitudinal ends which in the finished assembled state face towards one another are bonded with one another, once again for instance preferably by welding or alternatively by gluing.

The present application further concerns a motor vehicle, in particular a hybrid-electrically or fully electrically propelled motor vehicle, comprising a cooling circuit with a coolant equalizing reservoir configured according to the aforesaid description. The cooling circuit comprises a pump arrangement for producing a coolant flow in the cooling circuit, where the pump arrangement is configured to produce during proper normal cooling operation a volume flow of coolant of at least 12 l/min, preferably of at least 25 l/min, more preferably of at least 35 l/min.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1A partially cut elevation view of an equalizing reservoir according to the invention, cut along the section axis I-I of FIG. 3 which is parallel to the degassing chamber's axis,

FIG. 2A perspective view of the partially cut equalizing reservoir of FIG. 1, and

FIG. 3A top view of the inner region of the lower reservoir shell of the equalizing reservoir of FIGS. 1 and 2.

### DESCRIPTION OF PREFERRED EMBODIMENTS

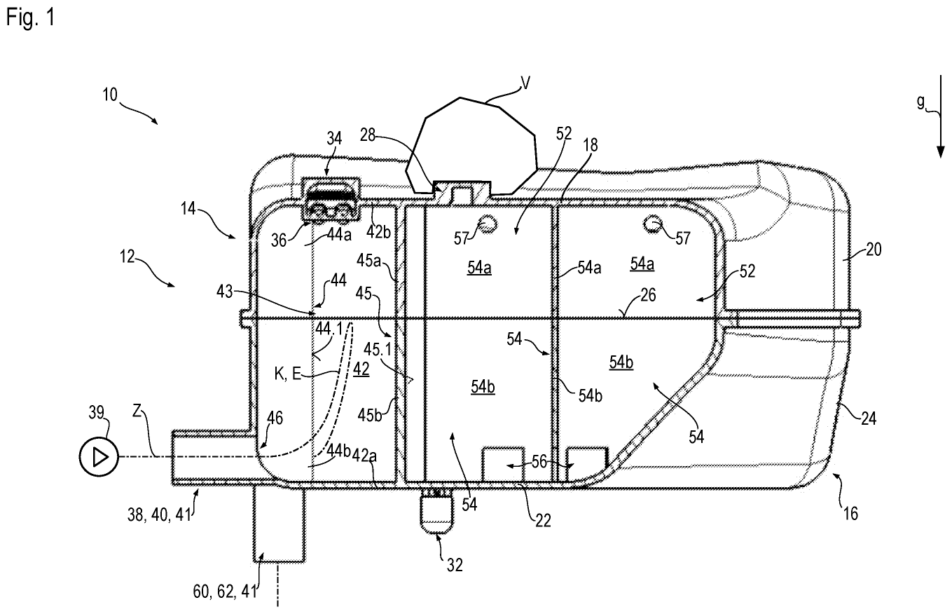

Referring now to the drawings wherein the showings are for the purpose of illustrating preferred and alternative embodiments of the invention only and not for the purpose of limiting the same, in FIGS. 1 to 3, an embodiment form according to the invention of a coolant equalizing reservoir is denoted generally by 10. The equalizing reservoir 10 exhibits a reservoir housing 12 and is formed from an upper reservoir shell 14 and a lower reservoir shell 16.

The upper reservoir shell 14 comprises a reservoir top 18 and an upper side-wall 20 projecting integrally from the reservoir top 18, encircling in a closed manner, as sections of the reservoir housing 12.

The lower reservoir shell 16 comprises a reservoir bottom 22 which in the operational state of the equalizing reservoir 10 is opposite to the reservoir top 18 and a lower side-wall 24 projecting integrally from the reservoir bottom 22, encircling in a closed manner, as sections of the reservoir housing 12. The upper and the lower reservoir shell 14 and/or 16 respectively are bonded with one another, in particular welded, for example by mirror welding or by another suitable welding method, along a joint plane 26.

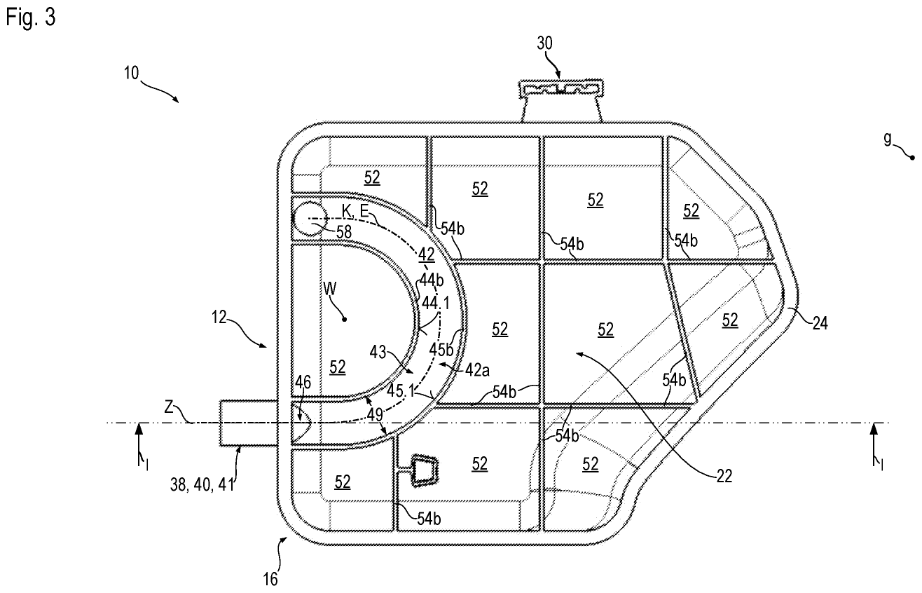

On the outside of the reservoir shells 14 and 16 there are molded functional formations, such as for example mountings 28, 30 (s. FIGS. 3), and 32 for attaching the equalizing reservoir 10 to a structure surrounding it, in particular the structure of a vehicle V. A further functional formation is the sensor mounting 34 which in the depicted example penetrates through the upper reservoir shell 14 and which holds a sensor arrangement 36 for detecting operational states of the equalizing reservoir 10 and/or properties of a coolant flowing through the equalizing reservoir 10.

In the region of the reservoir bottom 22, a tube 38 configured integrally with the lower reservoir shell 14 conducts at the lower reservoir shell 14 coolant into the equalizing reservoir 10 as part of a feed line 40. In the depicted example, the tube 38 and the feed line 40 proceed advantageously along a straight feed axis Z, conceived as penetrating centrally through the tube 38 and the feed line 40. The feed line 40 is part of a coolant circuit and/or cooling circuit respectively 41 in the motor vehicle V. This cooling circuit 41 comprises a pump 39, which during operation of the cooling circuit 41 produces volume flows of coolant of between 30 and 50 l/min.

Both reservoir shells 14 and 16 are produced in an injection molding process from a thermoplastic synthetic, preferably from polyethylene or polypropylene.

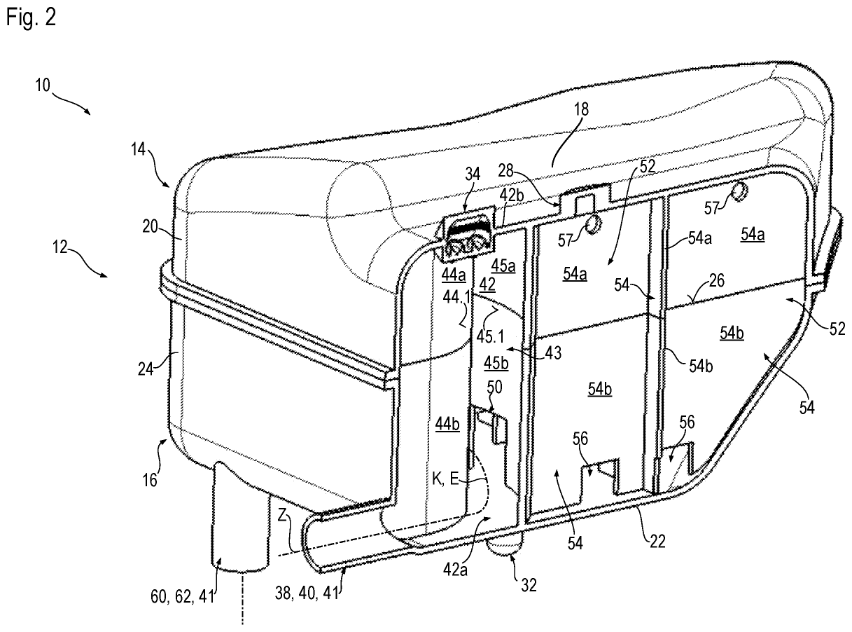

The equalizing reservoir 10 is depicted in FIGS. 1 and 2 in its operational spatial orientation. The arrow g indicates the gravitational direction. This proceeds parallel to the drawing plane of FIG. 1 and orthogonally to the drawing plane of FIG. 3.

Inside the equalizing reservoir 10 there is configured a duct-like degassing chamber 42 which extends continuously from the reservoir bottom 22 to the reservoir top 18. As an aid for easier description of the inner region of the equalizing reservoir 10, there is depicted a virtual degassing chamber axis W (s. FIG. 3) which proceeds outside the duct-like degassing chamber 42 orthogonally to the drawing plane of FIG. 3 and in the depicted embodiment example in parallel to the gravitational direction g. The degassing chamber 42 proceeds along a duct path K which defines a curved degassing flow path E, along which coolant flows through the degassing chamber 42 from an introducing inlet opening 46 to the outflow opening 58. The straight feed axis Z merges into the curved duct path K.

In the present case, the degassing chamber 42 is configured in two parts with approximately equal parts in the upper reservoir shell 14 and in the lower reservoir shell 16 each. The degassing chamber 42 is bounded by a first wall 44 and by a second wall 45 lying opposite to it across the degassing flow path E. The first and the second wall 44 and/or 45 respectively are also formed in two parts each by an upper wall 44a and/or 45a respectively and a lower wall 44b and/or 45b respectively. The upper first wall 44a configured integrally with the upper reservoir shell 14 and a lower first wall 44b configured integrally with the lower reservoir shell 16 meet in the joint plane 26 and are welded there with one another producing the wall 44 of the degassing chamber 42. The same applies mutatis mutandis to the second wall 45.

The first wall 44 is configured part-cylindrically and exhibits a convexly curved inner surface 44.1 when viewed from the interior space 43 of the degassing chamber 42. Opposite to it there is located the inner surface 45.1 of the second wall which in the depicted embodiment example is parallel to it and therefore concavely curved. The first wall 44 and the second wall 45 thus define between them a duct gap 49, which in the depicted embodiment example exhibits an essentially constant gap dimension from the inlet opening 46 of the feed line 40 to the outflow opening 58. In the depicted embodiment example, the aforementioned degassing chamber axis W is the common axis of curvature of the inner surfaces 44.1 and 45.1.

The feed line 40 penetrates through the lower side-wall 24 and opens into the degassing chamber 42 at the inlet opening 46. Coolant introduced into the degassing chamber 42 via the inlet opening 46 flows into the degassing chamber 42, and after striking the inner surface 45.1 of the second wall 45 is deflected into a degassing flow path oriented anticlockwise as viewed in FIG. 3.

The degassing chamber 42 extends with its lower first and second wall 44b and/or 45b respectively from a base-wall section 42a away along the degassing chamber axis W towards an end-wall section 42b. The base-wall section 42a is formed by a section of the reservoir bottom 22, the end-wall section 42b by a section of the reservoir top 18.

Coolant can flow via one or several passage apertures 50 in the first wall 44, in particular in the lower first wall 44b, and several passage apertures 50 in the second wall 45, in particular in the lower second wall 45b, from the degassing chamber 42 into the external environment of the degassing chamber 42 between the walls 44 and 45 of the degassing chamber 42 and the reservoir housing 12. Only one passage aperture 50 is discernible in FIG. 2.

On both sides outside the degassing chamber 42 there are formed expansion chambers 52, of which each two immediately adjacent expansion chambers 52 are separated from one another by one planar partition 54. The partitions 54 too, extend completely between the reservoir bottom 22 and the reservoir top 18. Like the walls 44 and 45 of the degassing chamber 42, every partition 54 in the depicted embodiment example is also formed by an upper partition 54a and a lower partition 54b, which contact one another in the joint plane 26 and are preferably bonded, especially preferably firmly bonded, with one another. Since the two reservoir shells 14 and 16 are preferably produced by injection molding, the upper and lower partitions 54a and/or 54b respectively in the depicted example are configured integrally with the reservoir housing 12, that is, with the reservoir top 18, reservoir bottom 22, and side-walls 20 and 24.

In every partition 54, in particular in every lower partition 54b, there is configured one communicating aperture 56 each through which coolant can flow from one side of the partition 54 to the other side of the partition 54.

The outflow opening 58 through which coolant can exit from the equalizing reservoir 10, can be discerned in FIG. 3. The outflow opening 58 opens directly into the degassing chamber 42, such that coolant has to travel only a short way in the duct-like degassing chamber 42 in order to leave it again. The degassing chamber 42 can also, however, unlike the depicted embodiment example, exhibit several consecutive curved sections, each with a different direction of curvature, such that the length of the degassing flow path E can be chosen arbitrarily within the specified dimensions of the equalizing reservoir 10. Thus the degassing chamber 42 can exhibit, instead of the U-shape depicted in FIGS. 1 to 3, an S-shaped form or generally proceed along a serpentine duct path. It is also not precluded that the degassing flow path E and thereby the degassing chamber 42 exhibit straight sections or are configured as straight overall.

The degassing chamber 42 exhibits one passage aperture 50 each in every expansion chamber 52 directly adjoining a wall 44 or 45.

All the partitions 54 exhibit one communicating aperture 56 each. Consequently, all the expansion chambers 52 located on the same side of the degassing chamber 42 communicate with one another. Whereas the majority, preferably all, of the communicating apertures 56 are configured at the lower partitions 54b, in particular bounded by the reservoir bottom 22, the upper partitions exhibit pressure equalization apertures 57 through which gas can flow at least between adjacent chambers 52 located on the same side of the degassing chamber 42, in order to ensure a uniform gas pressure in the equalizing reservoir 10 across all chambers 52 on the same side of the degassing chamber 42.

In the depicted embodiment example, the inlet opening 46 of the feed line 40 and the outflow opening 58 are located at approximately the same height when the equalizing reservoir 10 is installed operationally in a vehicle V standing on level ground. However, the tube 60 which joins the outflow opening 58 as an outlet line 62 and the tube 38 of the feed line 40 are differently oriented, in the depicted embodiment example inclined by approximately 90° relative to one another. Hereby there results a spatial flow inside the degassing chamber 42 with significant flow components along the degassing chamber axis W. Unlike the depicted embodiment form, both tubes 38 and 60 and/or the feed line 40 and the outlet line 62 respectively can also run with a component proceeding orthogonally to a spacing straight line which connects the inlet opening 46 with the outflow opening 58, in particular along the degassing chamber axis W, towards the inlet opening 46 and/or away from the outflow opening 58 respectively, in order to achieve, in addition to the forced flow from the inlet opening 46 to the outflow opening 58, also a flow along the degassing chamber axis W. The dwell time of the coolant in the degassing chamber 42 can thereby be increased.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-14. (canceled)

15. A coolant equalizing reservoir for arrangement in a coolant circuit, comprising:
a reservoir housing,
a degassing chamber in the reservoir housing, inside the former of which coolant flows along a curved degassing flow path,
a feed line for introducing coolant into the reservoir housing, and
an outflow opening for discharging coolant from the reservoir housing, where both the feed line and the outflow opening open into the degassing chamber, and where the degassing chamber is configured as a flow duct which proceeds along a curved duct path, where the curved duct path defines the degassing flow path.

16. The coolant equalizing reservoir according to claim 15, wherein the degassing chamber is bounded at least along a section of the course of the curved duct path by a first wall and by a second wall lying opposite the first wall, where an inner surface of a wall out of the first and the second wall, facing towards the interior space of the degassing chamber, is curved concavely along the section and where an inner surface of the respective other wall out of the first and the second wall lying opposite the concave inner surface is curved convexly along the section.

17. The coolant equalizing reservoir according to claim 16, wherein the concave inner surface and the convex inner surface proceed in parallel to one another.

18. The coolant equalizing reservoir according to claim 17, wherein the first and the second wall protrude from a base-wall section of the reservoir housing along a degassing chamber axis and are arranged orthogonally to the degassing chamber axis at a distance from one another.

19. The coolant equalizing reservoir according to claim 16, wherein the first and the second wall protrude from a base-wall section of the reservoir housing along a degassing chamber axis and are arranged orthogonally to the degassing chamber axis at a distance from one another.

20. The coolant equalizing reservoir according to claim 18, wherein each of the two walls out of the first and the second wall is arranged in a direction orthogonal to the degassing chamber axis at least along a section of the curved duct path at a distance from the reservoir housing.

21. The coolant equalizing reservoir according to claim 16, wherein each of the two walls out of the first and the second wall is arranged in a direction orthogonal to the degassing chamber axis at least along a section of the curved duct path at a distance from the reservoir housing.

22. The coolant equalizing reservoir according to claim 20, wherein at least one of the two walls comes out from a side-wall of the reservoir housing and preferably also ends in a side-wall of the reservoir housing.

23. The coolant equalizing reservoir according to claim 16, wherein at least one of the two walls comes out from a side-wall of the reservoir housing and preferably also ends in a side-wall of the reservoir housing.

24. The coolant equalizing reservoir according to claim 22, wherein the wall with the convex inner surface comes out from a side-wall of the reservoir housing and ends in a side-wall of the reservoir housing and thereby together with the reservoir housing encloses a spatial volume.

25. The coolant equalizing reservoir according to claim 24, wherein at least one wall out of the first and the second wall exhibits at least one passage aperture which completely penetrates through the wall in the thickness direction.

26. The coolant equalizing reservoir according to claim 16, wherein at least one wall, out of the first and the second wall exhibits at least one passage aperture which completely penetrates through the wall in the thickness direction.

27. The coolant equalizing reservoir according to claim 25, wherein at least one wall out of the first and the second wall exhibits a plurality of passage apertures which completely penetrate through the at least one wall in the thickness direction, where at least two of the passage apertures are arranged at different circumferential positions in the circumferential direction about the degassing chamber axis and/or are arranged at different positions in a direction along the degassing chamber axis and/or exhibit different shapes and/or different aperture cross-sectional areas.

28. The coolant equalizing reservoir according to claim 18, wherein the degassing chamber extends from the base-wall section of the reservoir housing along the degassing chamber axis up to an end-wall section of the reservoir housing lying opposite the base-wall section.

29. The coolant equalizing reservoir according to claim 15, wherein a region inside the reservoir housing but outside the degassing chamber is subdivided into a plurality of chambers which communicate with one another.

30. The coolant equalizing reservoir according to claim 29, wherein partitions which separate two neighboring chambers from one another exhibit a communicating aperture through which coolant can flow from one of the chambers into the respective other one.

31. The coolant equalizing reservoir according to claim 30, wherein the communicating apertures of at least two partitions are arranged at different distances from the degassing chamber and/or are arranged at different positions in a direction along the degassing chamber axis and/or exhibit different shapes and/or different aperture cross-sectional areas.

32. The coolant equalizing reservoir according to claim 31, wherein partitions which separate two neighboring chambers from one another extend from a reservoir bottom up to a reservoir top lying opposite the reservoir bottom.

33. The coolant equalizing reservoir according to claim 30, wherein partitions which separate two neighboring chambers from one another extend from a reservoir bottom up to a reservoir top lying opposite the reservoir bottom.
